(19) United States
(12) Patent Application Publication
(10) Pub. No.: US 2022/0404225 A1
(43) Pub. Date: Dec. 22, 2022

(54) Apparatus and Method for Identifying Positions of Tire Pressure Sensors, and System Including the Apparatus

(71) Applicants: Hyundai Motor Company, Seoul (KR); Kia Corporation, Seoul (KR)

(72) Inventor: Jung Hoon Oh, Seoul (KR)

(21) Appl. No.: 17/731,947

(22) Filed: Apr. 28, 2022

(30) Foreign Application Priority Data
Jun. 21, 2021 (KR) 10-2021-0080332

(51) Int. Cl. G01L 17/00; G01P 3/481; G01S 5/02; B60C 23/04

(52) U.S. Cl. CPC G01L 17/00; G01P 3/481; G01S 5/0269; B60C 23/0416; B60C 23/0488

(57) ABSTRACT

An embodiment tire pressure sensor position identification apparatus includes a receiver configured to receive signals from tire pressure sensors and to receive information about wheel pulse counts from wheel speed sensors, the tire pressure sensors being mounted on an inner wheel and an outer wheel of a vehicle to have a specific phase difference therebetween, and a controller configured to identify positions where the tire pressure sensors are mounted based on the specific phase difference, the signals received from the tire pressure sensors, and the wheel pulse counts.

### CROSS-REFERENCE TO RELATED APPLICATIONS

This application claims the benefit of Korean Patent Application No. 10-2021-0080332, filed on Jun. 21, 2021, which application is hereby incorporated herein by reference.

### TECHNICAL FIELD

The present disclosure relates to an apparatus and method for identifying positions of tire pressure sensors and a system including the apparatus.

### BACKGROUND

A tire pressure monitoring system (TPMS) is a system that receives information, such as pressure, temperature, and the like, from tire pressure sensors mounted on respective wheels and displays a warning of low pressure and air-pressure information for each wheel on a driver display window. A wheel speed sensor of a vehicle is a device capable of measuring wheel speed by identifying wheel pulse information.

In the case of a car or van whose wheels have a single tire, the positions of four wheel sensors may be identified by using a TPMS sensor and vehicle information. However, in the case of a vehicle whose rear wheels have dual tires, it is difficult to identify the positions of two sensors mounted on inner and outer wheels. In other words, with the current technology, it is difficult to determine whether low pressure occurs in the inner or outer wheel, and therefore a high-line TPMS that displays the individual positions of low-pressure tires cannot be implemented. Accordingly, a technology for determining whether a TPMS sensor is mounted on an inner or outer wheel is required.

### SUMMARY

The present disclosure relates to an apparatus and method for identifying positions of tire pressure sensors and a system including the apparatus. Particular embodiments relate to an apparatus and method for identifying positions of tire pressure sensors of dual tires and a system including the apparatus.

Embodiments of the present disclosure can solve problems occurring in the prior art while advantages achieved by the prior art are maintained intact.

An embodiment of the present disclosure provides an apparatus and method for identifying positions of tire pressure sensors of dual tires and a system including the apparatus.

Another embodiment of the present disclosure provides a tire pressure sensor position identification apparatus and method for identifying positions of tire pressure sensors of dual tires and accurately determining the position of a tire whose pressure is lowered, and a system including the apparatus.

Another embodiment of the present disclosure provides a tire pressure sensor position identification apparatus and method for enabling a TPMS to be equipped in a commercial vehicle using dual tires rather than just in a passenger vehicle, and a system including the apparatus.

Another embodiment of the present disclosure provides a tire pressure sensor position identification apparatus and method for economically identifying positions of tire pressure sensors without an additional apparatus by using signals of the tire pressure sensors and wheel speed sensors of a vehicle using dual tires, and a system including the apparatus.

Another embodiment of the present disclosure provides a tire pressure sensor position identification apparatus and method for enabling a TPMS to be equipped in a vehicle using dual tires and enabling a commercial vehicle using dual tires to safely travel by monitoring tire pressure in real time, and a system including the apparatus.

The technical problems to be solved by embodiments of the present disclosure are not limited to the aforementioned problems, and any other technical problems not mentioned herein will be clearly understood from the following description by those skilled in the art to which the present disclosure pertains.

According to an embodiment of the present disclosure, a tire pressure sensor position identification apparatus includes a receiver that receives signals from tire pressure sensors and receives information about wheel pulse counts from wheel speed sensors, the tire pressure sensors being mounted on inner and outer wheels of a vehicle to have a specific phase difference therebetween and a controller that identifies positions where the tire pressure sensors are mounted, based on the specific phase difference, the signals received from the tire pressure sensors, and the wheel pulse counts.

In an embodiment, the controller may set a reference value for a wheel pulse count difference, based on the number of saw teeth of a tone wheel for the wheel speed sensors and the specific phase difference of the tire pressure sensors.

In an embodiment, the controller may identify the positions where the tire pressure sensors are mounted, based on the wheel pulse counts at the time when the signals are received from the tire pressure sensors.

In an embodiment, the controller may identify the positions where the tire pressure sensors are mounted, by comparing a difference between the wheel pulse counts at the time when the signals are received from the tire pressure sensors with a preset reference value for a wheel pulse count difference.

In an embodiment, the controller may determine whether each of the tire pressure sensors is mounted on the inner or outer wheel of the vehicle, based on whether a difference between the wheel pulse counts at the time when the signals are received from the tire pressure sensors is equal to a preset reference value for a wheel pulse count difference.

In an embodiment, the receiver may receive the signals generated every time the tire pressure sensors are located at specific points of the rotating wheels of the vehicle.

According to another embodiment of the present disclosure, a tire pressure sensor position identification system includes tire pressure sensors that are mounted on inner and outer wheels of a vehicle to have a specific phase difference therebetween and that transmit signals to a tire pressure sensor position identification apparatus, wheel speed sensors that transmit information about wheel pulse counts to the tire pressure sensor position identification apparatus, and the tire pressure sensor position identification apparatus that identifies positions where the tire pressure sensors are mounted, based on the specific phase difference, the signals received from the tire pressure sensors, and the wheel pulse counts.

In an embodiment, the tire pressure sensor position identification apparatus may set a reference value for a wheel pulse count difference, based on the number of saw teeth of a tone wheel for the wheel speed sensors and the specific phase difference of the tire pressure sensors.

In an embodiment, the tire pressure sensor position identification apparatus may identify the positions where the tire pressure sensors are mounted, based on the wheel pulse counts at the time when the signals are received from the tire pressure sensors.

In an embodiment, the tire pressure sensor position identification apparatus may identify the positions where the tire pressure sensors are mounted, by comparing a difference between the wheel pulse counts at the time when the signals are received from the tire pressure sensors with a preset reference value for a wheel pulse count difference.

In an embodiment, the tire pressure sensor position identification apparatus may determine whether each of the tire pressure sensors is mounted on the inner or outer wheel of the vehicle, based on whether a difference between the wheel pulse counts at the time when the signals are received from the tire pressure sensors is equal to a preset reference value for a wheel pulse count difference.

In an embodiment, the tire pressure sensors may generate the signals every time the tire pressure sensors are located at specific points of the rotating wheels of the vehicle and may transmit the signals to the tire pressure sensor position identification apparatus.

In an embodiment, the tire pressure sensors may measure acceleration and may determine whether the tire pressure sensors are located at the specific points of the wheels of the vehicle, based on the measured acceleration.

According to another embodiment of the present disclosure, a tire pressure sensor position identification method includes transmitting, by tire pressure sensors mounted on inner and outer wheels of a vehicle to have a specific phase difference therebetween, signals to a tire pressure sensor position identification apparatus, transmitting, by wheel speed sensors, information about wheel pulse counts to the tire pressure sensor position identification apparatus, and identifying, by the tire pressure sensor position identification apparatus, positions where the tire pressure sensors are mounted, based on the specific phase difference, the signals received from the tire pressure sensors, and the wheel pulse counts.

In an embodiment, the tire pressure sensor position identification method may further include setting, by the tire pressure sensor position identification apparatus, a reference value for a wheel pulse count difference, based on the number of saw teeth of a tone wheel for the wheel speed sensors and the specific phase difference of the tire pressure sensors.

In an embodiment, the identifying of the positions where the tire pressure sensors are mounted may include identifying, by the tire pressure sensor position identification apparatus, the positions where the tire pressure sensors are mounted, based on the wheel pulse counts at the time when the signals are received from the tire pressure sensors.

In an embodiment, the identifying of the positions where the tire pressure sensors are mounted may include identifying, by the tire pressure sensor position identification apparatus, the positions where the tire pressure sensors are mounted, by comparing a difference between the wheel pulse counts at the time when the signals are received from the tire pressure sensors with a preset reference value for a wheel pulse count difference.

In an embodiment, the identifying of the positions where the tire pressure sensors are mounted may include determining, by the tire pressure sensor position identification apparatus, whether each of the tire pressure sensors is mounted on the inner or outer wheel of the vehicle, based on whether a difference between the wheel pulse counts at the time when the signals are received from the tire pressure sensors is equal to a preset reference value for a wheel pulse count difference.

In an embodiment, the transmitting of the signals to the tire pressure sensor position identification apparatus may include generating, by the tire pressure sensors, the signals every time the tire pressure sensors are located at specific points of the rotating wheels of the vehicle and transmitting the signals to the tire pressure sensor position identification apparatus.

In an embodiment, the generating of the signals every time the tire pressure sensors are located at the specific points of the rotating wheels of the vehicle and the transmitting of the signals to the tire pressure sensor position identification apparatus may include measuring, by the tire pressure sensors, acceleration and determining whether the tire pressure sensors are located at the specific points of the wheels of the vehicle, based on the measured acceleration.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a block diagram illustrating a tire pressure sensor position identification apparatus according to an embodiment of the present disclosure;

FIG. 2 is a block diagram illustrating a tire pressure sensor position identification system according to an embodiment of the present disclosure;

FIGS. 3A and 3B are views illustrating tire pressure sensors mounted on an inner wheel and an outer wheel of a vehicle according to an embodiment of the present disclosure;

FIG. 4 is a view illustrating information about a wheel pulse count obtained by a wheel speed sensor according to an embodiment of the present disclosure;

FIG. 5 is a view illustrating generation of signals by tire pressure sensors according to an embodiment of the present disclosure;

FIG. 6 illustrates graphs depicting signals generated by tire pressure sensors and information about a wheel pulse count obtained by a wheel speed sensor according to an embodiment of the present disclosure;

FIG. 7 is a flowchart illustrating a process of identifying, by a tire pressure sensor position identification apparatus, positions where tire pressure sensors are mounted according to an embodiment of the present disclosure; and

FIG. 8 is a flowchart illustrating a tire pressure sensor position identification method according to an embodiment of the present disclosure.

### DETAILED DESCRIPTION OF ILLUSTRATIVE EMBODIMENTS

Hereinafter, some embodiments of the present disclosure will be described in detail with reference to the drawings. In adding the reference numerals to the components of each drawing, it should be noted that the identical or equivalent component is designated by the identical numeral even when they are displayed on other drawings. Further, in describing the embodiments of the present disclosure, a detailed description of well-known features or functions will be omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

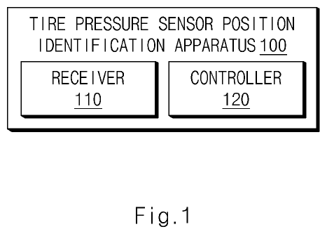

Hereinafter, embodiments of the present disclosure will be described in detail with reference to FIGS. 1 to 8.

FIG. 1 is a block diagram illustrating a tire pressure sensor position identification apparatus according to an embodiment of the present disclosure.

Referring to FIG. 1, the tire pressure sensor position identification apparatus 100 may include a receiver 110 and a controller 120.

The tire pressure sensor position identification apparatus 100 according to embodiments of the present disclosure may be implemented inside or outside a vehicle. The tire pressure sensor position identification apparatus 100 may be integrally formed with control units inside the vehicle, or may be implemented as a separate hardware apparatus and may be connected with the control units of the vehicle by connecting means.

For example, the tire pressure sensor position identification apparatus 100 may be integrated with the vehicle, may be implemented in a form that is installed on/attached to the vehicle as a component separate from the vehicle, or may be implemented in a form in which a part is integrated with the vehicle and another part is installed on/attached to the vehicle as a component separate from the vehicle.

The receiver 110 may receive signals from tire pressure sensors and may receive information about wheel pulse counts from wheel speed sensors, the tire pressure sensors being mounted on inner and outer wheels of the vehicle to have a specific phase difference therebetween.

For example, the receiver 110 may receive radio frequency (RF) signals from the tire pressure sensors.

For example, the receiver 110 may receive the information about the wheel pulse counts from the wheel speed sensors through controller area network (CAN) communication.

For example, the receiver 110 may include communication circuitry capable of receiving an RF signal and communication circuitry providing a CAN communication function.

For example, the receiver 110 may be directly or indirectly connected with the controller 120 through wireless or wired communication and may transfer, to the controller 120, the signals received from the tire pressure sensors and the wheel pulse count information received from the wheel speed sensors.

For example, the tire pressure sensors may be mounted on the inner and outer wheels of the vehicle, which have the same axis of rotation, so as to have the specific phase difference and may rotate together with the inner and outer wheels of the vehicle while always maintaining the specific phase difference as the inner and outer wheels of the vehicle rotate at the same speed.

For example, the receiver 110 may receive signals generated every time the tire pressure sensors are located at specific points of the wheels of the vehicle.

For example, the specific points of the wheels of the vehicle may be determined to be the uppermost points of the wheels. In this case, the receiver 110 may receive RF signals generated by the tire pressure sensors every time the tire pressure sensors are located at the uppermost points of the wheels of the vehicle.

The controller 120 may identify the positions where the tire pressure sensors are mounted, based on the specific phase difference, the signals received from the tire pressure sensors, and the wheel pulse counts.

For example, the controller 120 may determine whether each of the tire pressure sensors is mounted on the inner or outer wheel of the vehicle.

For example, the controller 120 may previously store, in a memory, information about the specific phase difference set when the tire pressure sensors are mounted on tires and may use the specific phase difference in the process of identifying the positions where the tire pressure sensors are mounted.

For example, the controller 120 may identify the positions where the tire pressure sensors are mounted, based on the wheel pulse counts at the time when the signals are received from the tire pressure sensors.

Specifically, the controller 120 may monitor, in real time, the wheel pulse counts received from the wheel speed sensors and may store, in the memory, the wheel pulse count values at the time when the signals are received from the tire pressure sensors.

In addition, the controller 120 may store, in the memory, wheel pulse count values at the time when signals are received from the tire pressure sensors next time.

For example, the controller 120 may identify the positions where the tire pressure sensors are mounted, by comparing a difference between the wheel pulse counts at the time when the signals are received from the tire pressure sensors with a preset reference value for a wheel pulse count difference.

Specifically, the controller 120 may calculate a difference between the wheel pulse count values at the time when the signals are received from the tire pressure sensors and may identify the positions where the tire pressure sensors are mounted, by comparing the calculated wheel pulse count difference with the preset reference value for the wheel pulse count difference.

For example, the controller 120 may set the reference value for the wheel pulse count difference, based on the number of saw teeth of a tone wheel and the specific phase difference of the tire pressure sensors.

For example, the controller 120 may calculate a wheel pulse count generated by the specific phase difference of the tire pressure sensors and may set the calculated wheel pulse count value as the reference value for the wheel pulse count difference.

For example, the controller 120 may set the reference value for the wheel pulse count difference such that the wheel pulse count is proportional to the number of saw teeth of the tone wheel and the specific phase difference of the tire pressure sensors.

For example, the controller 120 may determine whether each of the tire pressure sensors is mounted on the inner or outer wheel of the vehicle, based on whether the difference between the wheel pulse counts at the time when the signals are received from the tire pressure sensors is equal to the preset reference value for the wheel pulse count difference.

For example, in the case where the tire pressure sensor mounted on the outer wheel is ahead of the tire pressure sensor mounted on the inner wheel by the specific phase difference, when the wheel pulse count at the time when a firstly received signal is received minus the wheel pulse count at the time when a secondly received signal is received is equal to the reference value for the wheel pulse count difference that is set based on the specific phase difference, the controller 120 may determine that the tire pressure sensor corresponding to the firstly received signal is mounted on the inner wheel and the tire pressure sensor corresponding to the secondly received signal is mounted on the outer wheel.

For example, in the case where the tire pressure sensor mounted on the outer wheel is ahead of the tire pressure sensor mounted on the inner wheel by the specific phase difference, when the wheel pulse count at the time when the firstly received signal is received minus the wheel pulse count at the time when the secondly received signal is received is not equal to the reference value for the wheel pulse count difference that is set based on the specific phase difference, the controller 120 may determine that the tire pressure sensor corresponding to the firstly received signal is mounted on the outer wheel and the tire pressure sensor corresponding to the secondly received signal is mounted on the inner wheel.

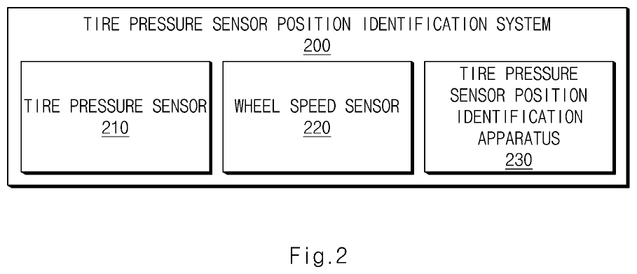

FIG. 2 is a block diagram illustrating a tire pressure sensor position identification system according to an embodiment of the present disclosure.

Referring to FIG. 2, the tire pressure sensor position identification system 200 may include tire pressure sensors 210, wheel speed sensors 220, and a tire pressure sensor position identification apparatus 230.

The tire pressure sensors 210 may be mounted on inner and outer wheels of a vehicle so as to have a specific phase difference and may transmit signals to the tire pressure sensor position identification apparatus 230.

For example, the tire pressure sensors 210 may be mounted on the inner and outer wheels of the vehicle that have the same axis of rotation and may rotate together as the inner and outer wheels of the vehicle rotate.

For example, the tire pressure sensors 210 may include communication circuitry that performs an original function of measuring air pressure in a tire and generates and transmits an RF signal to the tire pressure sensor position identification apparatus 230.

For example, the tire pressure sensors 210 may generate signals every time the tire pressure sensors 210 are located at specific points of the wheels of the vehicle and may transmit the signals to the tire pressure sensor position identification apparatus 230.

For example, the tire pressure sensors 210 may generate RF signals every time the tire pressure sensors 210 are located at the uppermost points of the wheels of the vehicle and may transmit the RF signals to the tire pressure sensor position identification apparatus 230.

As the tire pressure sensors 210 transmit the signals to the tire pressure sensor position identification apparatus 230 every time the tire pressure sensors 210 are located at the specific points of the wheels of the vehicle, the tire pressure sensor position identification apparatus 230 may periodically receive the signals from the tire pressure sensors 210.

For example, the tire pressure sensors 210 may measure acceleration and may determine whether the tire pressure sensors 210 are located at the specific points of the wheels of the vehicle, based on the measured acceleration.

For example, the tire pressure sensors 210 may be mounted to measure acceleration in a rotational direction of the wheels and may measure acceleration in the rotational direction of the wheels in real time.

As the wheels rotate, the degree to which the gravity is exerted in the rotational direction of the wheels may be changed, and therefore acceleration measured by the tire pressure sensors 210 may be changed in real time.

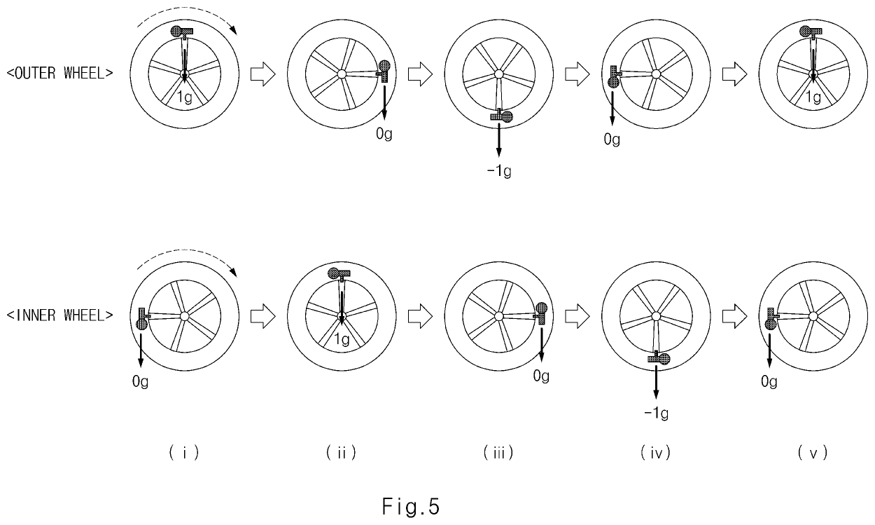

The process in which the tire pressure sensors 210 measure acceleration and determine whether the tire pressure sensors 210 are located at the specific points of the wheels of the vehicle based on the measured acceleration will be described below in more detail with reference to FIG. 5.

The wheel speed sensors 220 may transmit information about wheel pulse counts to the tire pressure sensor position identification apparatus 230.

For example, the wheel speed sensors 220 may include communication circuitry capable of transmitting the information about the wheel pulse counts to the tire pressure sensor position identification apparatus 230 through CAN communication.

For example, the wheel speed sensors 220 may measure a wheel pulse count generated by saw teeth of a tone wheel, and when the wheels make one revolution, a wheel pulse count corresponding to the number of saw teeth of the tone wheel may be measured.

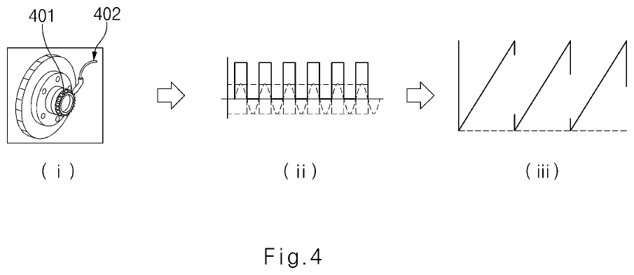

Wheel pulse counts measured by the wheel speed sensors 220 will be described below in more detail with reference to FIG. 4.

The tire pressure sensor position identification apparatus 230 may identify the positions where the tire pressure sensors 210 are mounted, based on the specific phase difference, the signals received from the tire pressure sensors 210, and the wheel pulse counts.

For example, the tire pressure sensor position identification apparatus 230 may identify the positions where the tire pressure sensors 210 are mounted, based on the wheel pulse counts at the time when the signals are received from the tire pressure sensors 210.

For example, the tire pressure sensor position identification apparatus 230 may set a reference value for a wheel pulse count difference, based on the number of saw teeth of the tone wheel and the specific phase difference of the tire pressure sensors 210.

For example, the tire pressure sensor position identification apparatus 230 may identify the positions where the tire pressure sensors 210 are mounted, by comparing the difference between the wheel pulse counts at the time when the signals are received from the tire pressure sensors 210 with the preset reference value for the wheel pulse count difference.

For example, the tire pressure sensor position identification apparatus 230 may determine whether each of the tire pressure sensors 210 is mounted on the inner or outer wheel of the vehicle, based on whether the difference between the wheel pulse counts at the time when the signals are received from the tire pressure sensors 210 is equal to the preset reference value for the wheel pulse count difference.

The tire pressure sensor position identification apparatus 230 is the same as the tire pressure sensor position identification apparatus 100 of FIG. 1, and therefore specific description thereabout will be omitted.

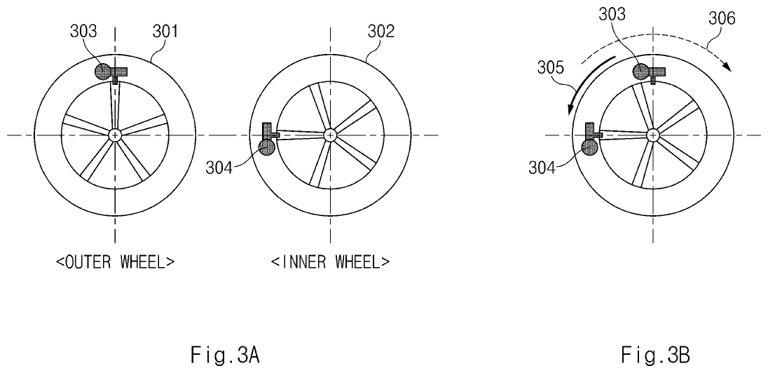

FIGS. 3A and 3B are views illustrating tire pressure sensors mounted on an inner wheel and an outer wheel of a vehicle according to an embodiment of the present disclosure.

Referring to FIG. 3A, the tire pressure sensors 210 may include the tire pressure sensor 303 mounted on the outer wheel 301 of the vehicle and the tire pressure sensor 304 mounted on the inner wheel 302 of the vehicle.

The tire pressure sensor 303 mounted on the outer wheel 301 of the vehicle may obtain tire pressure of the outer wheel 301 and may rotate together with the outer wheel 301 when the vehicle travels.

The tire pressure sensor 304 mounted on the inner wheel 302 of the vehicle may obtain tire pressure of the inner wheel 302 and may rotate together with the inner wheel 302 when the vehicle travels.

The tire pressure sensor 303 mounted on the outer wheel 301 of the vehicle may generate an RF signal and transmit the RF signal to the tire pressure sensor position identification apparatus 100 or 230 every time the tire pressure sensor 303 is located at a specific point of the outer wheel 301 during rotation of the outer wheel 301, and the tire pressure sensor 304 mounted on the inner wheel 302 of the vehicle may generate an RF signal and transmit the RF signal to the tire pressure sensor position identification apparatus 100 or 230 every time the tire pressure sensor 304 is located at a specific point of the inner wheel 302 during rotation of the inner wheel 302.

Referring to FIG. 3B, the tire pressure sensor 303 mounted on the outer wheel 301 of the vehicle and the tire pressure sensor 304 mounted on the inner wheel 302 of the vehicle may be mounted on the outer wheel 301 and the inner wheel 302 so as to have a specific phase difference 305.

For example, the specific phase difference 305 may be defined as the difference between the angle from a preset reference line whose center coincides with the axis of rotation of the wheels of the vehicle to the tire pressure sensor 303 mounted on the outer wheel 301 of the vehicle and the angle from the preset reference line to the tire pressure sensor 304 mounted on the inner wheel 302 of the vehicle.

For example, the tire pressure sensor 303 may be mounted on the outer wheel 301 of the vehicle so as to be ahead of the tire pressure sensor 304, which is mounted on the inner wheel 302 of the vehicle, by the specific phase difference 305 in a rotational direction 306 of the wheels.

The tire pressure sensor 303 mounted on the outer wheel 301 of the vehicle and the tire pressure sensor 304 mounted on the inner wheel 302 of the vehicle may rotate together while maintaining the specific phase difference 305 as the outer wheel 301 and the inner wheel 302 having the same axis of rotation rotate.

FIG. 4 is a view illustrating information about a wheel pulse count obtained by a wheel speed sensor according to an embodiment of the present disclosure.

Referring to part (i) of FIG. 4, the wheel speed sensor 402 may measure a wheel pulse count generated by a tone wheel 401 as a wheel rotates.

For example, the wheel speed sensor 402 may measure the wheel pulse count by sensing a change of magnetic lines of force by the tone wheel 401.

Part (ii) of FIG. 4 is a view illustrating a change of magnetic lines of force by the tone wheel 401 that is measured by the wheel speed sensor 402.

For example, the change of the magnetic lines of force by the tone wheel 401 that is measured by the wheel speed sensor 402 may periodically form a predetermined wheel pulse waveform as the wheel rotates.

For example, based on the waveform generated by the change of the magnetic lines of force by the tone wheel 401, the wheel speed sensor 402 may convert the waveform into the form of a square wave.

For example, the wheel speed sensor 402 may generate a wheel pulse waveform in the form of a square wave, which has a value of 1 in an interval having a positive level and has a value of o in an interval having a negative level, from the waveform generated by the change of the magnetic lines of force by the tone wheel 401.

Part (iii) of FIG. 4 is a graph depicting a wheel pulse count over time.

For example, the wheel speed sensor 402 may accumulatively count pulses in the wheel pulse waveform in the form of a square wave of part (ii) of FIG. 4 in real time.

Because the wheel pulse count increases by the number of saw teeth of the tone wheel 401 every time the wheel makes one revolution, the wheel speed sensor 402 may calculate, in real time, the remainder obtained by dividing the number of pluses accumulatively counted by the number of saw teeth of the tone wheel 401.

The wheel speed sensor 402 may transfer information about the measured wheel pulse count to the tire pressure sensor position identification apparatus 100 or 230 through CAN communication.

FIG. 5 is a view illustrating generation of signals by tire pressure sensors according to an embodiment of the present disclosure.

FIG. 5 illustrates a process (e.g., using positions (i) to (v)) in which tire pressure sensors mounted on inner and outer wheels of a vehicle measure acceleration while rotating together with the inner and outer wheels of the vehicle.

For example, the tire pressure sensors mounted on the inner and outer wheels of the vehicle may be configured to transmit RF signals in the state in which acceleration values measured by acceleration sensors included in the tire pressure sensors are 1 g.

Here, 1 g may be defined as an acceleration value that means 1 times the acceleration of gravity.

For example, the tire pressure sensor mounted on the outer wheel of the vehicle may be ahead of the tire pressure sensor mounted on the inner wheel of the vehicle by a phase difference of 90 degrees in a rotational direction of the wheels.

Here, the phase difference of 90 degrees is provided for illustration only, and the phase difference may be determined to be a different angle.

In position (i) of FIG. 5, the tire pressure sensor mounted on the outer wheel may be located at the uppermost position of the outer wheel and may measure an acceleration of 1 g, and the tire pressure sensor mounted on the inner wheel may be located at the leftmost position of the inner wheel and may measure an acceleration of 0 g.

Here, og may be defined as an acceleration value that means o times the acceleration of gravity.

In this case, the tire pressure sensor mounted on the outer wheel may generate an RF signal and may transmit the RF signal to the tire pressure sensor position identification apparatus.

In position (ii) of FIG. 5, the tire pressure sensor mounted on the outer wheel may be located at the rightmost position of the outer wheel and may measure an acceleration of 0 g, and the tire pressure sensor mounted on the inner wheel may be located at the uppermost position of the inner wheel and may measure an acceleration of 1 g.

In this case, the tire pressure sensor mounted on the inner wheel may generate an RF signal and may transmit the RF signal to the tire pressure sensor position identification apparatus.

In position (iii) of FIG. 5, the tire pressure sensor mounted on the outer wheel may be located at the lowermost position of the outer wheel and may measure an acceleration of -ig, and the tire pressure sensor mounted on the inner wheel may be located at the rightmost position of the inner wheel and may measure an acceleration of 0 g.

Here, −1 g may be defined as an acceleration value that means −1 times the acceleration of gravity.

In this case, the two tire pressure sensors may not generate an RF signal.

In position (iv) of FIG. 5, the tire pressure sensor mounted on the outer wheel may be located at the leftmost position of the outer wheel and may measure an acceleration of og, and the tire pressure sensor mounted on the inner wheel may be located at the lowermost position of the inner wheel and may measure an acceleration of −1 g.

In this case, the two tire pressure sensors may not generate an RF signal.

In position (v) of FIG. 5, the tire pressure sensor mounted on the outer wheel may be located at the uppermost position of the outer wheel and may measure an acceleration of 1 g, and the tire pressure sensor mounted on the inner wheel may be located at the leftmost position of the inner wheel and may measure an acceleration of 0 g.

In this case, the tire pressure sensor mounted on the outer wheel may generate an RF signal and may transmit the RF signal to the tire pressure sensor position identification apparatus.

The tire pressure sensors mounted on the inner and outer wheels of the vehicle may transmit an RF signal once while the wheels of the vehicle make one revolution.

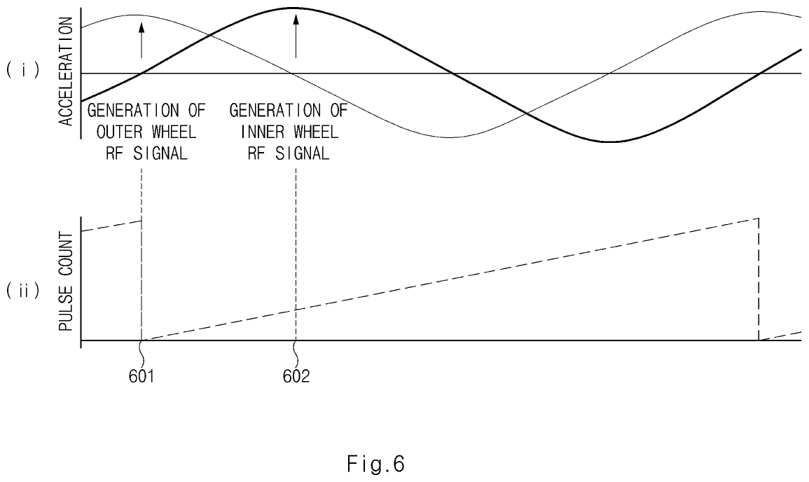

FIG. 6 illustrates graphs depicting signals generated by tire pressure sensors and information about a wheel pulse count obtained by a wheel speed sensor according to an embodiment of the present disclosure.

Upper graph (i) of FIG. 6 is a graph depicting acceleration measured by the tire pressure sensors over time, and lower graph (ii) of FIG. 6 is a graph depicting the wheel pulse count measured by the wheel speed sensor over time.

For example, the tire pressure sensors mounted on inner and outer wheels of a vehicle may be configured to transmit RF signals when acceleration values measured by acceleration sensors included in the tire pressure sensors are 1 g that is the highest value. The tire pressure sensors may transmit RF signals every time the tire pressure sensors are located at the uppermost positions of the wheels.

For example, the tire pressure sensor position identification apparatus may store a wheel pulse count value at the time 601 of receiving an RF signal from the tire pressure sensor mounted on the outer wheel of the vehicle, and the wheel pulse count value may be a.

For example, the tire pressure sensor position identification apparatus may store a wheel pulse count value at the time 602 of receiving an RF signal from the tire pressure sensor mounted on the inner wheel of the vehicle, and the wheel pulse count value may be α+β.

The tire pressure sensor position identification apparatus may obtain β by calculating the difference between the wheel pulse count value at the time 601 and the wheel pulse count value at the time 602.

For example, when the wheels make one revolution, a wheel pulse count corresponding to the number of saw teeth of a tone wheel may be generated.

When the tire pressure sensors transmit RF signals at the same positions of the wheels every predetermined period, the wheel pulse count may be increased by the value obtained by multiplying the RPM of the wheels by the number of saw teeth of the tone wheel.

For example, in the case where the number of saw teeth of the tone wheel is 48 and the wheel pulse count when the first RF signal is transmitted is a, the wheel pulse count when the next RF signal is transmitted may be 48*n+α that is increased by n (RPM)*48 (the number of saw teeth of the tone wheel).

Here, the number of saw teeth set to 48 is merely illustrative, and the number of saw teeth may be determined to be a different value.

Accordingly, the tire pressure sensor may measure the remainder obtained by dividing the wheel pulse count measured by the wheel speed sensor over time by the number of saw teeth of the tone wheel.

That is, in this case, even though the RPM (n) of the wheels is considered, the wheel pulse count difference corresponding to the two tire pressure sensors may be a specific value of 48*n+12.

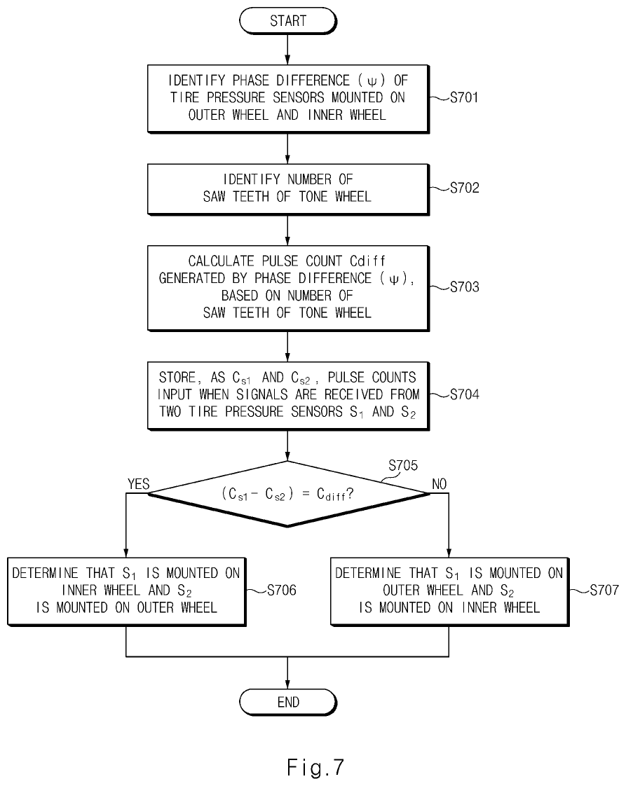

FIG. 7 is a flowchart illustrating a process of identifying, by the tire pressure sensor position identification apparatus, positions where tire pressure sensors are mounted according to an embodiment of the present disclosure.

Referring to FIG. 7, the tire pressure sensor position identification apparatus 100 or 230 may identify the phase difference ψ of tire pressure sensors mounted on an outer wheel and an inner wheel (S701).

For example, the tire pressure sensor position identification apparatus 100 or 230 may identify the phase difference ψ of the tire pressure sensors mounted on the outer wheel and the inner wheel, through information about a specific phase difference previously stored in a memory and set when the tire pressure sensors are mounted on tires.

The tire pressure sensor position identification apparatus 100 or 230 may identify the number of saw teeth of a tone wheel (S702) after identifying the phase difference ψ of the tire pressure sensors mounted on the outer wheel and the inner wheel (S701).

For example, the tire pressure sensor position identification apparatus 100 or 230 may identify the number of saw teeth of the tone wheel through information about the number of saw teeth of the tone wheel that is set and stored when a vehicle is designed and manufactured.

The tire pressure sensor position identification apparatus 100 or 230, after identifying the number of saw teeth of the tone wheel (S702), may calculate a pulse count Cdiff generated by the phase difference ψ, based on the number of saw teeth of the tone wheel (S703).

For example, the tire pressure sensor position identification apparatus 100 or 230 may calculate the pulse count generated by the phase difference ψ such that the pulse count is proportional to the number of saw teeth of the tone wheel and the phase difference ψ.

For example, the tire pressure sensor position identification apparatus 100 or 230 may calculate the pulse count generated by the phase difference ψ, through the equation Cdiff=Cp (the number of saw teeth of the tone wheel)*ψ(the phase difference)/360°.

For example, when the number of saw teeth of the tone wheel is 48 and the phase difference ψ is 90 degrees, the tire pressure sensor position identification apparatus 100 or 230 may calculate the pulse count generated by the phase difference ψ to be 48 (the number of saw teeth of the tone wheel)*90(the phase difference)/360°=12.

The tire pressure sensor position identification apparatus 100 or 230 may store, as Cs1 and Cs2, wheel pulse counts input at the time when signals are received from the two tire pressure sensors S1 and S2 (S704), after calculating the pulse count generated by the phase difference ψ, based on the number of saw teeth of the tone wheel (S703).

For example, the tire pressure sensor position identification apparatus 100 or 230 may monitor, in real time, information about wheel pulse counts received from two wheel speed sensors mounted on the inner wheel and the outer wheel and may store, as Cs1 and Cs2, wheel pulse counts at the time when RF signals are received from the two tire pressure sensors S1 and S2.

The tire pressure sensor position identification apparatus 100 or 230 may determine whether (Cs1−Cs2) is equal to Cdiff (S705), after storing, as Csi and Cs2, the wheel pulse counts input at the time when the signals are received from the two tire pressure sensors Si and S2 (S704).

For example, the tire pressure sensor position identification apparatus 100 or 230 may determine that (Cs1−Cs2) is equal to Cdiff when there is a difference less than a preset threshold value between (Cs1−Cs2) and Cdiff.

After determining whether (Cs1−Cs2) is equal to Cdiff (S705), the tire pressure sensor position identification apparatus 100 or 230 may determine that the tire pressure sensor Si is mounted on the inner wheel and the tire pressure sensor S2 is mounted on the outer wheel (S706), when it is determined that (Cs1−Cs2) is equal to Cdiff (Yes at S705).

For example, when (Cs1−Cs2) is equal to Cdiff, the wheel pulse count of the tire pressure sensor S1 is larger than the wheel pulse count of the tire pressure sensor S2 by the phase difference ψ, and therefore the tire pressure sensor position identification apparatus 100 or 230 may determine that the tire pressure sensor Si is mounted on the inner wheel and the tire pressure sensor S2 is mounted on the outer wheel.

After determining whether (Cs1−Cs2) is equal to Cdiff (S705), the tire pressure sensor position identification apparatus 100 or 230 may determine that the tire pressure sensor Si is mounted on the outer wheel and the tire pressure sensor S2 is mounted on the inner wheel (S707), when it is determined that (Cs1−Cs2) is not equal to Cdiff (No at S705).

For example, when (Cs1−Cs2) is not equal to Cdiff, the wheel pulse count of the tire pressure sensor S1 is not larger than the wheel pulse count of the tire pressure sensor S2 by the phase difference ψ, and therefore the tire pressure sensor position identification apparatus 100 or 230 may determine that the tire pressure sensor S1 is not mounted on the inner wheel (i.e., the tire pressure sensor S1 is mounted on the outer wheel) and the tire pressure sensor S2 is not mounted on the outer wheel (i.e., the tire pressure sensor S2 is mounted on the inner wheel).

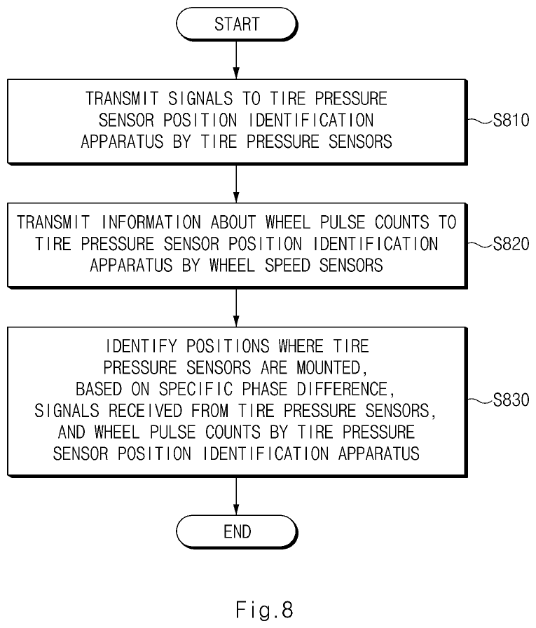

FIG. 8 is a flowchart illustrating a tire pressure sensor position identification method according to an embodiment of the present disclosure.

Referring to FIG. 8, the tire pressure sensor position identification method may include a step of transmitting, by tire pressure sensors, signals to the tire pressure sensor position identification apparatus (S810), a step of transmitting, by wheel speed sensors, information about wheel pulse counts to the tire pressure sensor position identification apparatus (S820), and a step of identifying, by the tire pressure sensor position identification apparatus, the positions where the tire pressure sensors are mounted, based on a specific phase difference, the signals received from the tire pressure sensors, and the wheel pulse counts (S830).

For example, the step of transmitting, by the tire pressure sensors, the signals to the tire pressure sensor position identification apparatus (S810) may include a step of generating, by the tire pressure sensors, signals every time they are located at specific points of wheels of a vehicle and transmitting the signals to the tire pressure sensor position identification apparatus.

For example, the step of generating, by the tire pressure sensors, the signals every time they are located at the specific points of the wheels of the vehicle and transmitting the signals to the tire pressure sensor position identification apparatus may include a step of measuring, by the tire pressure sensors, acceleration and determining whether the tire pressure sensors are located at the specific points of the wheels of the vehicle, based on the measured acceleration.

For example, the tire pressure sensor position identification method may further include a step of setting, by the tire pressure sensor position identification apparatus, a reference value for a wheel pulse count difference, based on the number of saw teeth of a tone wheel and the specific phase difference of the tire pressure sensors.

For example, the step of identifying, by the tire pressure sensor position identification apparatus, the positions where the tire pressure sensors are mounted (S830) may include a step of identifying, by the tire pressure sensor position identification apparatus, the positions where the tire pressure sensors are mounted, based on wheel pulse counts at the time when signals are received from the tire pressure sensors.

For example, the step of identifying, by the tire pressure sensor position identification apparatus, the positions where the tire pressure sensors are mounted (S830) may include a step of identifying, by the tire pressure sensor position identification apparatus, the positions where the tire pressure sensors are mounted, by comparing a difference between the wheel pulse counts at the time when the signals are received from the tire pressure sensors with the reference value for the wheel pulse count difference.

For example, the step of identifying, by the tire pressure sensor position identification apparatus, the positions where the tire pressure sensors are mounted (S830) may include a step of determining whether each of the tire pressure sensors is mounted on an outer wheel or an inner wheel, based on whether the difference between the wheel pulse counts at the time when the signals are received from the tire pressure sensors is equal to the reference value for the wheel pulse count difference.

The operations of the method or the algorithm described in connection with the embodiments disclosed herein may be embodied directly in hardware or a software module executed by a processor, or in a combination thereof. The software module may reside on a storage medium (that is, a memory and/or storage) such as a RAM, a flash memory, a ROM, an EPROM, an EEPROM, a register, a hard disk, a removable disk, or a CD-ROM.

The storage medium may be coupled to the processor, and the processor may read information out of the storage medium and may record information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

The apparatus and method for identifying the positions of tire pressure sensors and the system including the apparatus according to embodiments of the present disclosure have the following effects.

According to the embodiments of the present disclosure, the apparatus and method for identifying the positions of tire pressure sensors of dual tires and the system including the apparatus may be provided.

According to the embodiments of the present disclosure, the tire pressure sensor position identification apparatus and method and the system including the apparatus may identify the positions of tire pressure sensors of dual tires and may accurately determine the position of a tire whose pressure is lowered.

According to the embodiments of the present disclosure, the tire pressure sensor position identification apparatus and method and the system including the apparatus may enable a TPMS to be equipped in a commercial vehicle using dual tires rather than just in a passenger vehicle.

According to the embodiments of the present disclosure, the tire pressure sensor position identification apparatus and method and the system including the apparatus may economically identify the positions of tire pressure sensors without an additional apparatus by using signals of the tire pressure sensors and wheel speed sensors of a vehicle using dual tires.

According to the embodiments of the present disclosure, the tire pressure sensor position identification apparatus and method and the system including the apparatus may enable a TPMS to be equipped in a vehicle using dual tires and may enable a commercial vehicle using dual tires to safely travel by monitoring tire pressure in real time.

In addition, embodiments of the present disclosure may provide various effects that are directly or indirectly recognized.

Hereinabove, although the present disclosure has been described with reference to embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A tire pressure sensor position identification apparatus comprising:
a receiver configured to receive signals from tire pressure sensors and to receive information about wheel pulse counts from wheel speed sensors, the tire pressure sensors being mounted on an inner wheel and an outer wheel of a vehicle to have a specific phase difference therebetween; and
a controller configured to identify positions where the tire pressure sensors are mounted based on the specific phase difference, the signals received from the tire pressure sensors, and the wheel pulse counts.

2. The tire pressure sensor position identification apparatus of claim 1, wherein the controller is configured to set a reference value for a wheel pulse count difference based on a number of saw teeth of a tone wheel for the wheel speed sensors and the specific phase difference of the tire pressure sensors.

3. The tire pressure sensor position identification apparatus of claim 1, wherein the controller is configured to identify the positions where the tire pressure sensors are mounted based on the wheel pulse counts at a time when the signals are received from the tire pressure sensors.

4. The tire pressure sensor position identification apparatus of claim 1, wherein the controller is configured to identify the positions where the tire pressure sensors are mounted by comparing a difference between the wheel pulse counts at a time when the signals are received from the tire pressure sensors with a preset reference value for a wheel pulse count difference.

5. The tire pressure sensor position identification apparatus of claim 1, wherein the controller is configured to determine whether each of the tire pressure sensors is mounted on the inner wheel or the outer wheel of the vehicle based on whether a difference between the wheel pulse counts at a time when the signals are received from the tire pressure sensors is equal to a preset reference value for a wheel pulse count difference.

6. The tire pressure sensor position identification apparatus of claim 1, wherein the receiver is configured to receive the signals generated every time the tire pressure sensors are located at specific points of rotation of the wheels of the vehicle.

7. A tire pressure sensor position identification system comprising:
tire pressure sensors mounted on an inner wheel and an outer wheel of a vehicle to have a specific phase difference therebetween and configured to transmit signals to a tire pressure sensor position identification apparatus;
wheel speed sensors configured to transmit information about wheel pulse counts to the tire pressure sensor position identification apparatus; and
the tire pressure sensor position identification apparatus configured to identify positions where the tire pressure sensors are mounted based on the specific phase difference, the signals received from the tire pressure sensors, and the wheel pulse counts.

8. The tire pressure sensor position identification system of claim 7, wherein the tire pressure sensor position identification apparatus is configured to set a reference value for a wheel pulse count difference based on a number of saw teeth of a tone wheel for the wheel speed sensors and the specific phase difference of the tire pressure sensors.

9. The tire pressure sensor position identification system of claim 7, wherein the tire pressure sensor position identification apparatus is configured to identify the positions where the tire pressure sensors are mounted based on the wheel pulse counts at a time when the signals are received from the tire pressure sensors.

10. The tire pressure sensor position identification system of claim 7, wherein the tire pressure sensor position identification apparatus is configured to identify the positions where the tire pressure sensors are mounted by comparing a difference between the wheel pulse counts at a time when the signals are received from the tire pressure sensors with a preset reference value for a wheel pulse count difference.

11. The tire pressure sensor position identification system of claim 7, wherein the tire pressure sensor position identification apparatus is configured to determine whether each of the tire pressure sensors is mounted on the inner wheel or the outer wheel of the vehicle based on whether a difference between the wheel pulse counts at a time when the signals are received from the tire pressure sensors is equal to a preset reference value for a wheel pulse count difference.

12. The tire pressure sensor position identification system of claim 7, wherein the tire pressure sensors are configured to generate the signals every time the tire pressure sensors are located at specific points of rotation of the wheels of the vehicle and to transmit the signals to the tire pressure sensor position identification apparatus.

13. The tire pressure sensor position identification system of claim 12, wherein the tire pressure sensors are configured to measure acceleration and to determine whether the tire pressure sensors are located at the specific points of the wheels of the vehicle based on the measured acceleration.

14. A tire pressure sensor position identification method comprising:
transmitting, by tire pressure sensors mounted on an inner wheel and an outer wheel of a vehicle to have a specific phase difference therebetween, signals to a tire pressure sensor position identification apparatus;
transmitting, by wheel speed sensors, information about wheel pulse counts to the tire pressure sensor position identification apparatus; and
identifying, by the tire pressure sensor position identification apparatus, positions where the tire pressure sensors are mounted based on the specific phase difference, the signals received from the tire pressure sensors, and the wheel pulse counts.

15. The tire pressure sensor position identification method of claim 14, further comprising setting, by the tire pressure sensor position identification apparatus, a reference value for a wheel pulse count difference based on a number of saw teeth of a tone wheel for the wheel speed sensors and the specific phase difference of the tire pressure sensors.

16. The tire pressure sensor position identification method of claim 14, wherein identifying the positions where the tire pressure sensors are mounted comprises identifying, by the tire pressure sensor position identification apparatus, the positions where the tire pressure sensors are mounted based on the wheel pulse counts at a time when the signals are received from the tire pressure sensors.

17. The tire pressure sensor position identification method of claim 14, wherein identifying the positions where the tire pressure sensors are mounted comprises identifying, by the tire pressure sensor position identification apparatus, the positions where the tire pressure sensors are mounted by comparing a difference between the wheel pulse counts at a time when the signals are received from the tire pressure sensors with a preset reference value for a wheel pulse count difference.

18. The tire pressure sensor position identification method of claim 14, wherein identifying the positions where the tire pressure sensors are mounted comprises determining, by the tire pressure sensor position identification apparatus, whether each of the tire pressure sensors is mounted on the inner wheel or the outer wheel of the vehicle based on whether a difference between the wheel pulse counts at a time when the signals are received from the tire pressure sensors is equal to a preset reference value for a wheel pulse count difference.

19. The tire pressure sensor position identification method of claim 14, wherein transmitting the signals to the tire pressure sensor position identification apparatus comprises generating, by the tire pressure sensors, the signals every time the tire pressure sensors are located at specific points of rotation of the wheels of the vehicle and transmitting the signals to the tire pressure sensor position identification apparatus.

20. The tire pressure sensor position identification method of claim 19, wherein generating the signals every time the tire pressure sensors are located at the specific points of rotation of the wheels of the vehicle and transmitting the signals to the tire pressure sensor position identification apparatus comprises measuring, by the tire pressure sensors, acceleration and determining whether the tire pressure sensors are located at the specific points of the wheels of the vehicle based on the measured acceleration.
